(19) United States
(12) Patent Application Publication
(10) Pub. No.: US 2002/0094315 A1
(43) Pub. Date: Jul. 18, 2002

(54) Pyrolytic conversion of scrap tires to carbon products

(76) Inventors: R. William Mengel, Laramie, WY (US); Timothy P. Karpetsky, Towson, MD (US)

Correspondence Address: Roland H. Shubert, Post Office Box 2339, Reston, VA, 20195, US

(21) Appl. No.: 10/040,401

(22) Filed: Jan. 9, 2002

Related U.S. Application Data
(60) Provisional application No. 60/261,206, filed on Jan. 16, 2001.

(51) Int. Cl. C09C 1/48

(52) U.S. Cl. 423/445 R; 423/449.7; 423/460

(57) ABSTRACT

The low temperature pyrolysis of shredded scrap vehicle tires and other rubber scrap material yields a char consisting of coarse, granular particles of carbon. Those granular particles are converted to ultrafine carbon products useful as fillers and pigments by means of resonance disintegration. During resonance disintegration the char granules and particles are subjected to intense high energy shock waves resulting in a carbon particle product in which typically over half of the carbon particulate volume is below one micron when dispersed in water. The surface properties of the carbon particles or of carbon blacks produced by conventional techniques can be further modified by reacting or coating the carbon with chemical compounds or coating agents during or immediately after the resonance disintegration to tailor the properties of the carbon product to its use.

### BACKGROUND OF THE INVENTION

1. Technical Field

This invention relates to a method for processing scrap tires and other discarded rubber items to obtain useful carbon products therefrom.

More specifically, this invention relates to a method for pyrolyzing scrap tires and other discarded rubber items to obtain a char, and to the further processing of that char to obtain carbon products suitable for use in a wide variety of industrial applications.

2. Description of Related Art

The pyrolytic conversion of scrap tires to obtain char and liquid and gaseous decomposition products is well known in the art. Such processes promise a useful and environmentally friendly solution to the disposal of a significant portion of the estimated 700 million scrap tires generated worldwide each year. However, to be economically successful, the process would have to be primarily supported through the sale of carbon based products in commodity markets. That has proven to be a significant barrier.

Pyrolytic char particles usually display a very wide size range, from less than one micron to more than one millimeter. The principal difficulty experienced in processing such char to obtain commercially acceptable products has been to obtain a very finely divided material of narrow particle size range having properties useful in rubber, elastomers inks, pigments and plastics.

Attempts to obtain a commercially acceptable carbon product are well documented in the prior art. One such approach is described in U.S. Pat. No. 3,644,131 to Gotshall. The Gotshall patent asserted that a carbon product equivalent in quality to high grade carbon blacks can be obtained by retorting scrap tires and then comminuting the resulting char using a fluid energy mill to obtain a product having an average particle size of less than about 2.5 microns. The fluid energy mill used by Gotshall operated on steam at a temperature of about 450° F. at the nozzle exit. His mill was arranged with opposed nozzles to cause the carbon particles carried in a first stream to impinge at sonic velocity upon carbon particles carried in a second stream causing autogenous grinding of the colliding particles. The finely divided carbon product was then coated with a portion of the heavy oils from the retort to obtain a stable product.

Fader, in U.S. Pat. No. 5,037,628, disclosed a process that is generally similar to that of Gotshall in that tires were pyrolyzed in a retort to obtain a char, and a finely divided carbon product was produced from that char. Fader found that his char consisted of agglomerations, or clusters, of finer carbon particles mixed with unitary grit like particles. A carbon product, asserted to be comparable to commercial grade carbon blacks, was obtained by agitating the char to selectively de-agglomerate the carbon clusters without affecting the unitary particles which were thereafter separated from the smaller carbon particles. An air swept hammer mill, modified to provide only agitation, was used to de-agglomerate the carbon clusters. Data presented in the patent showed that the char material after de-agglomeration displayed a particle size range in which 90% of the particles were less than 150 microns in size.

The problems experienced with existing approaches to the pyrolytic processing of scrap tires has served to limit their usefulness and success. The large capital costs and high operating expenses of a fluid energy mill makes that approach commercially impractical. Also, the grinding of char is a very demanding process. It requires production of a very fine and abrasive product at rates of one ton or more per hour on a continuous, day in and day out basis using simple, foolproof equipment in order to be economically viable. The low yield of fine material obtained by de-agglomeration diminishes the attractiveness of that approach. It is apparent that a process which alleviates and overcomes the deficiencies inherent in present practices would be a significant advance in the art.

### SUMMARY OF THE INVENTION

Scrap tires are shredded, steel wire is separated from the shredded rubber, and the rubber is then pyrolyzed in a retort to obtain a volatiles fraction and a char residue. The volatiles are condensed, and the condensed liquid may be further processed to obtain marketable products while the non-condensed gas may be burned as a fuel. Char from the retort is subjected to resonance disintegration to produce a finely divided carbon product that is superior in properties to carbon obtained by means of conventional comminution techniques. The surface characteristics of the carbon or of carbon blacks produced by conventional techniques may be further modified to obtain a wide variety of special purpose carbons by subjecting the carbon particles to chemical reaction during or immediately after the resonance disintegration. Alternatively or additionally the carbon product may be treated with organo-metallic coupling agents to render the carbon more easily dispersible in a liquid vehicle for use in plastics, elastomers, inks and similar products.

### BRIEF DESCRIPTION OF THE DRAWING

FIG. 1 is an illustrative flow sheet setting out the basic unit operations that make up the process and produce the novel products of this invention;

FIG. 2A is a plot of volume frequency vs. particle diameter of a standard reference carbon black dispersed in water before resonance disintegration;

FIG. 2B is the reference carbon black of FIG. 2A dispersed in water after resonance disintegration;

FIG. 3A is a plot of volume frequency vs. particle diameter of the standard reference carbon black of FIG. 2 dispersed in isopropanol rather than in water prior to resonance disintegration;

FIG. 3B is the reference carbon black of FIG. 3A dispersed in isopropanol after resonance disintegration;

FIG. 4A is a plot of volume frequency vs. particle diameter of pyrolytic char dispersed in water before resonance decomposition;

FIG. 4B is the pyrolytic char of FIG. 4A dispersed in water after a first resonance decomposition;

FIG. 4C is the pyrolytic char of FIG. 4B dispersed in water after a second resonance decomposition;

FIG. 5A is a plot of volume frequency vs. particle diameter of the pyrolytic char of FIG. 4 dispersed in isopropanol before resonance decomposition;

FIG. 5B is the pyrolytic char of FIG. 5A dispersed in isopropanol after a first resonance decomposition; and

FIG. 5C is the pyrolytic char of FIG. 5B dispersed in water after a second resonance decomposition.

### DESCRIPTION OF PREFERRED EMBODIMENTS OF THE INVENTION

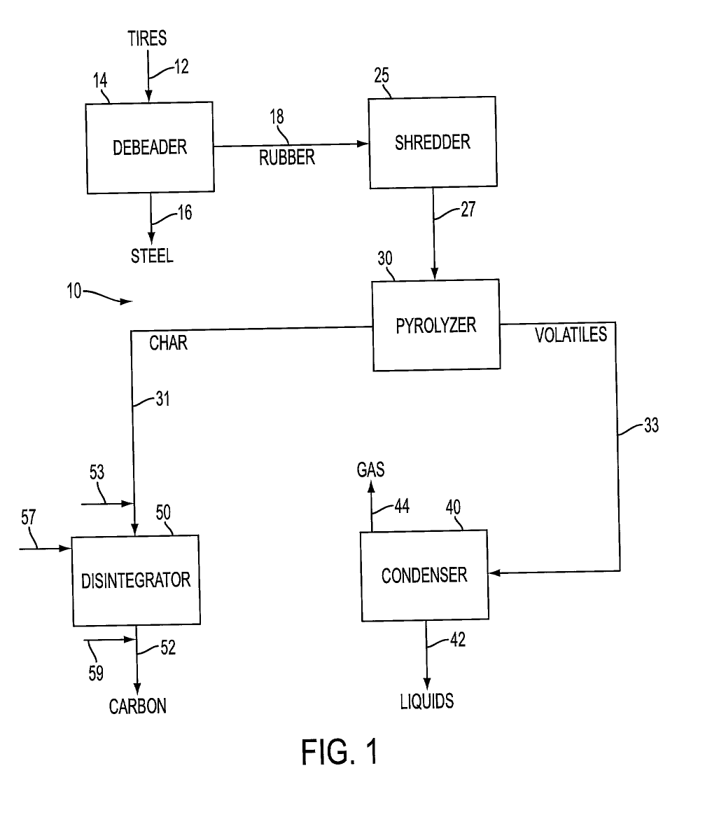

This invention utilizes a low temperature pyrolysis of rubber scrap, or suitably shredded scrap vehicle tires, to obtain a coarse, granular char that consists essentially of carbon. The char is then subjected to a size reduction step by means of resonance disintegration to obtain commercially useful carbon materials. Illustrative and preferred embodiments of this invention will be described in relation to the flowsheet 10 that is depicted in FIG. 1 of the drawing.

Referring now to FIG. 1, scrap vehicle tires 12 are first debeaded at 14 to separate the wire reinforcement in the tire bead from the remainder of the tire carcass. A steel fraction 16, comprising the reinforcing wire, is collected from the debeading operation while the debeaded tire 18 is passed to a shredder 25. Shredder 25 mechanically chops the debeaded tire into relatively small pieces or shreds 27 that suitably are no larger than about 50 mm in greatest dimension.

Shreds 27 are then passed to a pyrolyzing operation 30 wherein the rubber shreds are heat decomposed to obtain a char fraction 31 and a volatiles fraction 33. The pyrolyzing operation is preferably carried out in batch fashion using an externally heated, closed rotating retort. The use of a rotating retort is preferred in that it ensures even heating of the rubber and char product and also tends to prevent warping or cracking of the retort. Successive charges of shredded rubber are sealed into the retort which is then heated until the rubber is pyrolyzed and emission of volatiles ceases. Pyrolysis is ordinarily completed at the time emission of volatiles ceases when the retort charge is at a temperature typically in the range of 450° to 650° C. The retort is then cooled, the char discharged, and a new charge of shredded rubber is loaded.

Volatiles fraction 33 that is generated by the pyrolysis operation is passed to a condenser 40 to obtain a liquid product 42 and a non-condensable gas 44. Liquid 42 may be further processed by distillation and other refining techniques to obtain commercially useful products. The gas stream 44 contains combustible compounds and typically has a heating value about half that of natural gas. It preferably is burned on-site as process fuel to provide heat for the pyrolyzing operation and other similar uses.

Char fraction 31 is then subjected to resonance disintegration in means 50 to convert the char to an ultrafine carbon product 52. The use of resonance disintegration to comminute the pyrolytic char is critical to the successful practice of this invention as it produces a very finely divided carbon product that has commercially desirable properties not obtainable using conventional milling or comminution techniques. Resonance disintegration means 50 comprises a machine that uses a plurality of spinning rotors within a multisided chamber to cause rapid compression and decompression of gas and particles as the materials pass through the machine. The spinning rotors also generate a large flow of air or other supplied gas that enters the machine through a feed port or tube located at the top of the machine. Materials to be disintegrated are introduced into the feed port and are carried through the machine in the flowing gas. Powerful shock waves are produced by the compression and decompression and those shock waves impart destructive resonance to particles as they pass through the machine. A suitable resonance disintegration means for use in this invention is described in U.S. Pat. No. 6,135,370 that issued on Oct. 24, 2000 to Charles A. Arnold. The entire disclosure of that patent is incorporated by reference herein.

Resonance forces developed in means 50 are augmented by vortex-generated shearing forces that are phased for delivery just at the time that particles approach and exceed their inherent limit of elasticity. The intensity of the resonance forces generated may be controlled by varying the rotational speed of the rotor over a range generally between 1,000 and 6,500 rpm. Once the elastic limit of a material is exceeded it shatters along planes of weakness that may be along a crystal plane or cleavage plane. Hard, crystalline materials with little elasticity are therefore readily micronized while highly elastic materials such as certain types of rubbers and plastics are more resistant to fragmentation. Upon analysis of the forces described above it is clear that particle size reduction in means 50 is accomplished in a different manner than that obtained through crushing and impact forces imparted in hammer, ball and jet mills.

Particulate char solids are carried through disintegration means 50 entrained in a gaseous medium 53 that is introduced with the char. Residence time of char particles in means 50 is very short; typically less than one second. The gaseous medium 53 may be atmospheric air, nitrogen, carbon dioxide, steam, and a variety of other gases and gas mixtures. There is very little contact between the solid char particles and the component parts of means 50, and that results in very little machine wear and very little contamination of the carbon with metals abraded from the machine.

Experimental data suggest that surface modification of the carbon particles takes place during resonance disintegration in air even at ambient temperature. Resonance disintegration causes a significant size reduction in both commercial carbon blacks and in pyrolytic char as determined when the materials are dispersed in water. Different degrees of particle fineness and differing surface chemistries can be obtained by adjustment of the resonance disintegration to obtain a broad range of different carbons that are useful in a range of different applications. Examination of the samples of both feed char and resonance-disintegrated product by means of scanning tunneling microscopy reveal distinct differences in carbon particle morphology after passage of the char through the resonance disintegration means. The carbon particles processed by resonance disintegration appeared fragmented, with fissures in the surface, compared to unprocessed particles. Pictures of resonance disintegrated pyrolytic char taken using atomic force microscopy (AFM) and transmission electron microscopy (TEM) show material similar in size and shape to a variety of standard carbon blacks. Particle statistical analysis of 10 TEM images from pyrolytic char produced by resonance disintegration, processed once or twice, showed that carbon agglomerates were slightly larger (15% ±2%) after the second processing. Granules of standard carbon or of agglomerates of the pyrolytic char are broken down in water and typically about 50% of the resulting carbon material has a particle size less than one micron. Dispersions of those same carbon powders in isopropanol display particle size distributions and size trends that are quite distinct from those in water. The submicron fraction has never been observed to be a significant portion of total particulate volume of resonance disintegrated samples of either a standard carbon black or pyrolytic char when dispersed in isopropanol. Most of the product is distributed in the 1-3 μm range. Also, there is a growth of presumed agglomerates sized above about 5 μm after initial resonance disintegration processing of a standard carbon black, and upon successive resonance disintegration treatments of pyrolytic char.

X-ray photoelectron spectroscopy (XPS) analysis clearly shows that different surface chemical changes take place on different carbons as they are subjected to resonance disintegration. The differences seen upon use of different dispersion solvents also provide useful information about the surface properties of the carbon particles. Water is a solvent having proton donor properties that are relatively more pronounced than its acceptor properties, while isopropanol is a strong proton acceptor and donor and provides hydrophobic regions. Because the carbon particles tend to solvate and deagglomerate in water and because those same particles have more of a tendency to stick together or agglomerate in isopropanol, it appears that the carbon surface becomes more hydrophilic with resonance disintegration. Dispersion in water then gives a more accurate measure of the size reduction obtained through resonance disintegration than does dispersion in other solvents such as isopropanol. The hydrophilic nature of the carbon particles that results from resonance disintegration also points to the potential usefulness of the unique products obtained as pigments in water-based printing inks.

It has also been found that other types of surface modification of the carbon particles can readily be accomplished by contacting the carbon with an appropriate reactant compound during or immediately after resonance disintegration. Properties of the carbon that can be modified include conductance, pH, wetability/dispersion, size, and interaction with other molecules when used as a filler. It is possible to carry out a number of different types of reactions while or after the char is passed through resonance disintegration means 50. A first type of reaction is that which exploits Van der Walls forces between the carbon substrate and a reactant molecule to bind materials to the surface of carbon particles. The reactant molecule, for example, may be a polynuclear aromatic hydrocarbon that has acidic, basic, neutral or other functional groups attached. Polynuclear aromatic hydrocarbons bind to carbon particles and are only removed at high temperature.

A second class of reaction that is useful in modifying carbon properties are those which involve a chemical reaction between functional groups present on the carbon substrate and those carried on a reactant molecule. Typical functional groups that may be employed include —CO₂H, —COCl, —OH, 'NH₂, and —SiR₂Cl. It is preferred that the functional groups carried on the reactant molecule be highly reactive because the irreversible reaction between the functional groups and the carbon surface can be nearly instantaneous and the consumption of the reactant molecule is therefore substantially complete. Typical reactant molecules include peroxides, chlorosilanes, and acid chlorides.

Treatment of the resonance-disintegrated carbon product with certain organo-metallic compounds, particularly those compounds known in the trade as coupling agents, is another useful approach to the production of special purpose compositions. Coupling agents act as molecular bridges at the interface between two substances, one substance being a carbon particle and the other substance being either a liquid or another solid. Particularly preferred coupling agents include liquid multi-functional titanates, zirconates and aluminates such as, for example, alkyl titanates. Treatment may be accomplished by spraying an atomized coupling agent into a fluidized or otherwise agitated suspension of carbon particles. The amount of coupling agent required for treatment is small, enough to form at least a partial monomolecular layer on the surfaces of the carbon particles. That amount is generally in the range of about 0.1% to 1.0% based upon carbon weight. Carbon particles treated in that manner can be easily prepared as a paste concentrate having from about 10 to 35 weight percent solids in a selected liquid vehicle. The concentrate can then be diluted with additional quantities of the liquid vehicle to form an ink. The liquid vehicle may be water, or it may be any one of a variety of organic solvents, including, for example, alcohols and paraffinic or aromatic solvents.

Yet another kind of reaction that may be used to modify carbon surfaces are those which employ photochemical reactions between the carbon surface, or functional groups on the carbon surface, and a functionalized reactant molecule. Those reactions are extremely rapid and essentially total consumption of the reactant can be obtained without need for a purification step to remove excess reactant.

No matter the type of reaction employed, the reactant material may be introduced into the system at various locations, just before means 50 at location 55, into an upper area of means 50 at location 57, or at the exit of means 50 at location 59. It is generally advantageous to introduce the reactant material at location 59 so that the reaction takes place immediately after the resonance disintegration with char having freshly prepared surfaces.

It is also possible to modify the surface of the carbon particles by coating that surface with a non-reactive material such as a mineral oil or other petroleum oil that may be introduced into means 50 at location 55, 57 or 59 as a fine liquid stream. A coating agent will serve to change the wetability of the carbon surfaces and thus enhance the ease of dispersion of the carbon into a substrate material. It can also influence the color of the carbon when used in ink formulations.

In another embodiment of this invention, resonance disintegration is employed to modify the properties of carbon blacks produced in conventional fashion by the incomplete combustion or thermal decomposition of natural gas or petroleum liquids. In this embodiment of the invention, the commercial carbon product is substituted for char stream 31 as a feed to resonance disintegration means 50. As was described with reference to a char feed, the surfaces of the carbon particles may be modified during or immediately after resonance disintegration by contacting the carbon with an appropriate reagent. That reagent may be any of those previously described in reference to the pyrolytic char, including without limitation those that utilize Van der Walls forces; those which involve a chemical reaction between functional groups carried on a reactant molecule and those present on the carbon substrate after resonance disintegration treatment; and those organo-metallic compounds that function as coupling agents. The modified carbon products so obtained are similar in properties and uses to those produced from pyrolytic char.

The following examples will serve to illustrate the results that are obtainable through use of the inventive process.

### EXAMPLE I

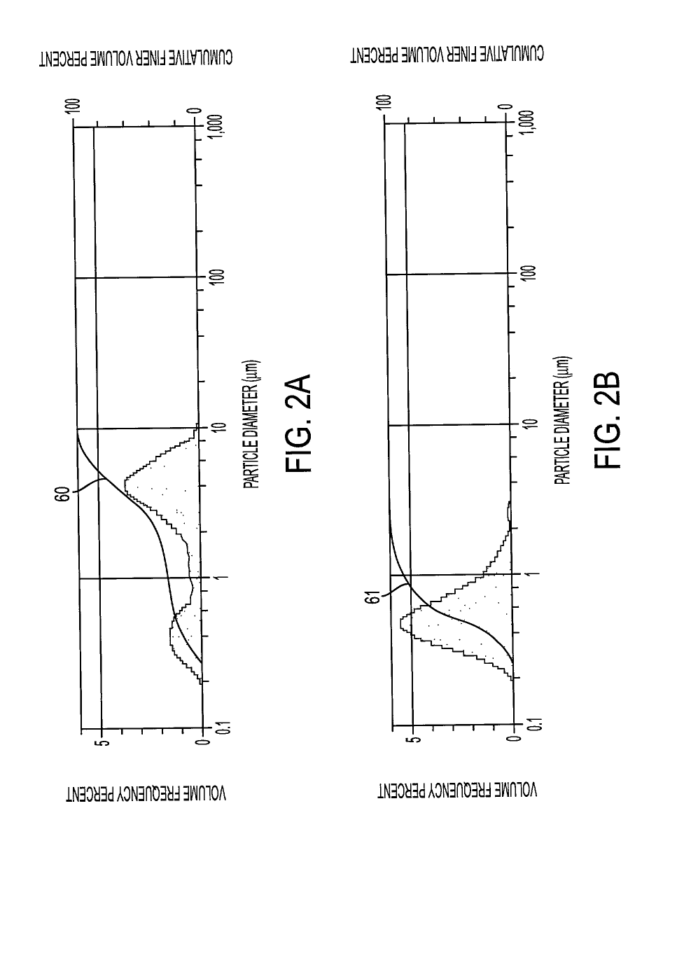

Approximately 50 kg of a dry, pelleted standard reference carbon black having the trade designation N660 was subjected to resonance disintegration using a standard, production size unit. The disintegration was conducted at ambient temperature using air as the carrier gas. Samples of the product were prepared as a suspension in water and the particle size distribution before and after resonance disintegration was determined. Those data are presented in graphical form in FIG. 2 that is a plot of volume frequency vs. particle diameter. The top graph panel, FIG. 2A, depicts the particle size distribution of the reference carbon black, N660, before resonance disintegration, and the bottom panel, FIG. 2B, depicts the same carbon black after resonance disintegration. Also included on each panel is a line plot 60, 61 showing cumulative finer volume percent.

Note the logarithmic scale on which the particle diameter is plotted. The changes induced by resonance disintegration were accompanied by significant alterations in particle size distributions. In water N660 is essentially bimodal perhaps representing an equilibrium among aggregate populations. Approximately 60% of the material is centered at 4.2 μm. After resonance disintegration that peak disappears completely and 90% of the agglomerates are below one micron in particle diameter. That deagglomeration is consistent with an increase in carbonyl functions on the carbon surface upon resonance disintegration as was determined by X-ray photoelectron spectroscopy (XPS) and also indicated by the interaction of those groups with water as a strong proton donor.

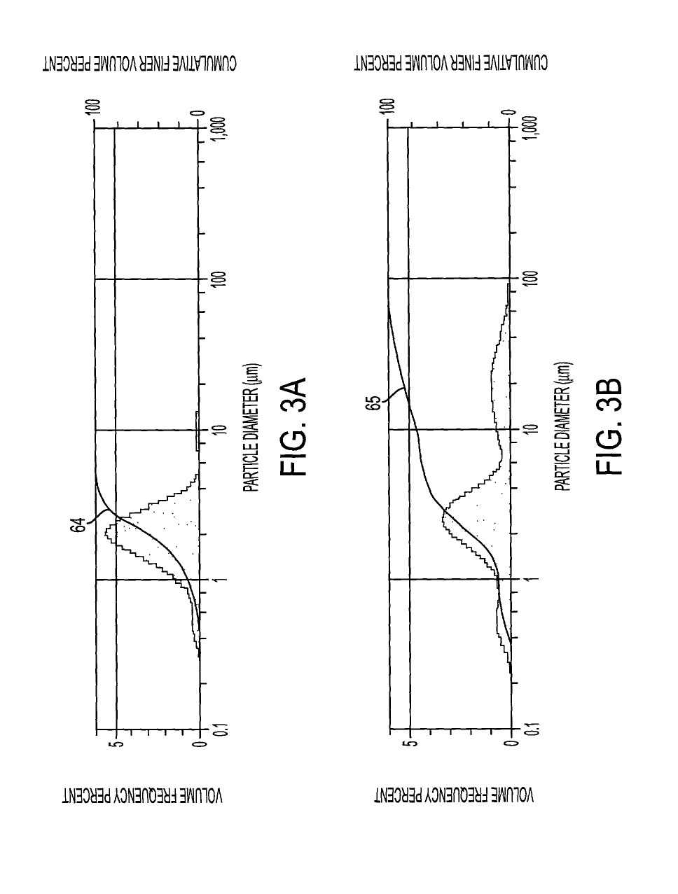

In isopropanol, which is more of a proton acceptor and less of a proton donor than is water, the opposite results are found. Those data are presented in graphical form as FIG. 3. Like FIG. 2, FIG. 3 is a plot of volume frequency vs. particle diameter. As in FIG. 2, the top graph panel, FIG. 3A, depicts the particle size distribution of the reference carbon black, N660, before resonance disintegration and the bottom panel, FIG. 3B, depicts the same carbon black after resonance disintegration. Also included on each panel is a line plot 64, 65 showing cumulative finer volume percent. From essentially a single peak at 2.0 μm with only 1.1% of the carbon above 5 μm, resonance disintegration produces a trimodal distribution of particle sizes with 28% of the material above 5 μm when dispersed in isopropanol. Thus, for N660, the mean particle size of 3.0 μm found in water moves down to 1.9 μm in isopropanol. However, for N660 that has been processed by resonance disintegration, the mean particle size of 0.54 μm in water moves up to 2.9 μm in isopropanol due to the changes of surface chemistry induced by these conditions of resonance disintegration

### EXAMPLE II

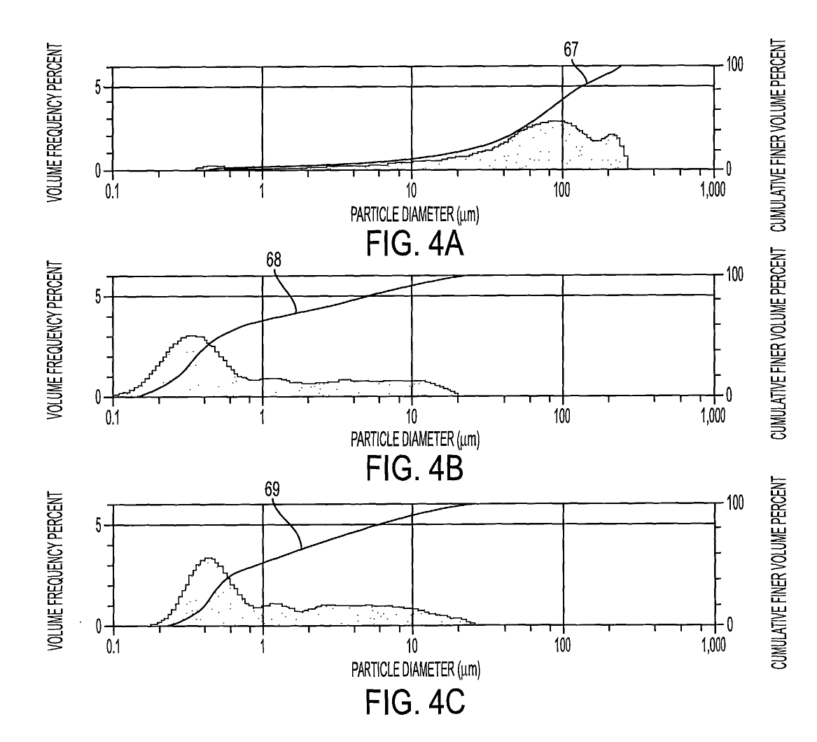

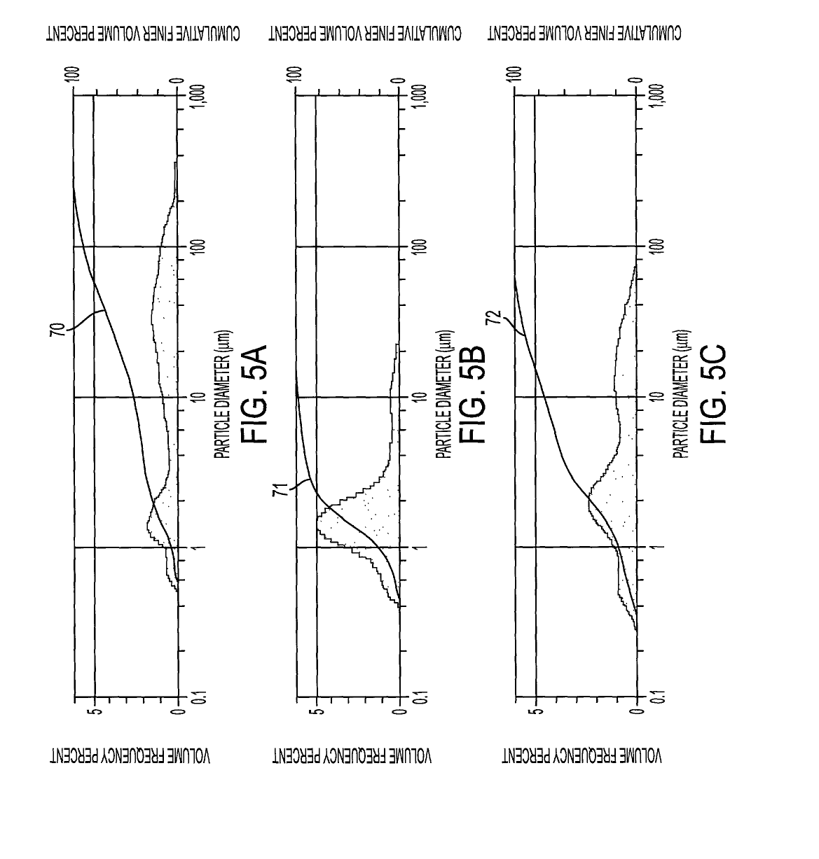

Approximately 50 kg of dry pyrolytic char derived from scrap tires was subjected to resonance disintegration at ambient temperature employing air as the gaseous medium under the same operating conditions as in Example I. Samples of the feed char and of the resonance-disintegrated product were prepared in both water and isopropanol and the size distribution of the samples was determined. Those data are presented graphical form in FIGS. 4 and 5, with FIG. 4 showing the water dispersed samples data and FIG. 5 showing the isopropanol dispersed samples data.

Turning now to FIG. 4, the three graph panels, FIGS. 4A, 4B and 4C, are each a plot of volume frequency vs. particle diameter. The top graph panel, FIG. 4A, depicts the particle size distribution of the pyrolytic char before resonance disintegration. The middle graph panel, FIG. 4B, shows the particle size distribution obtained after one pass through the resonance disintegration device, and the bottom graph panel, FIG. 4C, shows the particle size distribution after being twice subjected to resonance disintegration. Also shown on each panel is a line plot, 67, 68, 69, showing cumulative finer volume percent of the carbon particles. The data show a significant particle size reduction after resonance disintegration. Nearly 75% of the feed char was above 30 μm and less than 2% was submicron in size. One pass through resonance disintegration means 50 eliminated everything above 30 μm and increased the submicron fraction to one-half of the material. As is evident in comparing FIGS. 4B and 4C, a second pass of the carbon through the resonance disintegration unit did not significantly change the particle size distribution indicating the efficiency of the process.

As in FIG. 4, the three graph panels, FIGS. 5A, 5B and 5C, are each a plot of volume frequency vs. particle diameter, but dispersed in isopropanol rather than in water. The top graph panel, FIG. 5A, depicts the particle size distribution of the pyrolytic char before resonance disintegration. The middle graph, FIG. 5B, shows the particle size distribution obtained after one pass through the resonance disintegration device, and the bottom graph panel, FIG. 5C, shows the particle size distribution after the char has been twice subjected to resonance disintegration. As in FIG. 4, each panel includes a line plot, 70,71,72, showing cumulative finer volume percent of the carbon particles. The isopropanol dispersed samples displayed a trend similar to that of the water dispersed particles. About two-thirds of the feed char before resonance disintegration was larger than 5 μm and about 5% was smaller than 1 μm. A single pass through resonance disintegration means 50 reduced the largest particle, or agglomerate, size from over 350 μm to less than 30 μm. It increased the amount of material sized from 0.4 to 5 μm, centered at 1.5 μm, at the expense of 82% of the material over 5 μm. As is displayed in the bottom graph panel, a second pass of the carbon particles through resonance disintegration reduced the amount of material sized below 5 μm by about 32% and extended the range of largest particles from 28 to 71 μm.

Also significant is a comparison of the data presented in FIGS. 3A and 3B with that data presented in FIGS. 5B and 5C. As noted before, FIGS. 3A and 3B depict the particle size distribution in isopropanol of the reference carbon, N660, before and after resonance disintegration while FIGS. 5B and 5C depict the particle size distribution in isopropanol of pyrolytic char after one resonance disintegration treatment (FIG. 5B) and after a second resonance disintegration treatment (FIG. 5C.) Note the close likeness in size distribution of the reference carbon to the resonance disintegration-processed pyrolytic char and also the remarkable similarity in size distribution of the reference carbon after resonance disintegration to the size distribution of the pyrolytic char after a second resonance disintegration processing. Those similarities indicate a close sameness of properties between standard carbons and the carbon produced by the process of this invention.

EXAMPLE III

Portions of the carbon product obtained after resonance disintegration were supplied to several ink manufacturers for evaluation. The particle dimensions of the carbon was found to be consistent with ink applications. Any non-carbon grit or inorganic material present in the char was also so finely divided by the resonance disintegration that it did not pose a significant abrasion problem. The carbon was found to disperse well in a wide range of solvents including water, alcohol, toluene, and mineral spirits to form inks having an excellent matte finish with uniform ink distribution and good coverage. The ease of dispersion in water is considered to be especially significant in view of the environmental trend toward reducing use of solvent-based inks in favor of inks formulated with a water base.

### EXAMPLE IV

A sample of the carbon product obtained by resonance disintegration of pyrolytic char as in Example II was treated with a liquid alkyl titanate by spraying the atomized liquid into a fluidized suspension of carbon particles in a Henschel mixer. The treated composition was then mixed with sufficient water to form a viscous paste containing about 35% solids. The paste was stable with no separation of liquid and solids upon prolonged (>3 months) standing. The paste was thereafter easily dispersed into additional water to form an ink composition having any desired solids loading, thus indicating its usefulness as an ink concentrate or as a master batch formulation for compounding with rubbers and plastics.

Although the carbon product of this invention has been described as being particularly useful as a pigment in printing inks, it will find use as well in those other applications employing carbon as a pigment or as a filler. Other variations and modifications of the described embodiments will be apparent to those skilled in the art without departing from the spirit and scope of this invention, the scope of which is defined in the following claims.

What is claimed is:

1. A method for preparing carbon products from discarded rubber comprising the steps of:
pyrolyzing the rubber to obtain a volatiles fraction and a residual char; and
subjecting said char to resonance disintegration of an intensity sufficient to produce an ultrafine carbon powder, said powder characterized in having a particle size distribution when dispersed in water such that at least 75% by volume of the powder particles are less than 10 μm in diameter.

2. The method of claim 1 wherein said resonance disintegration is conducted at ambient temperature in an air medium.

3. The method of claim 1 wherein said discarded rubber comprises debeaded and shredded scrap vehicle tires.

4. The method of claim 1 wherein said rubber is pyrolyzed in an externally heated, closed retort at a temperature in the range of 450° to 650° C. until emission of volatiles ceases.

5. The method of claim 1 wherein said resonance-disintegrated carbon powder particles are subjected to a further treatment that modifies the surface properties of said powder particles.

6. The method of claim 5 wherein said treatment comprises contacting the carbon powder with a reactant compound during or after resonance disintegration.

7. The method of claim 6 wherein said reactant compound binds to particle surfaces through Van der Walls forces.

8. The method of claim 7 wherein said reactant compound comprises a polynuclear aromatic hydrocarbon.

9. The method of claim 6 wherein said reactant compound chemically reacts with functional groups present on the carbon particle surfaces.

10. The method of claim 9 wherein said reactant compound is selected from the group consisting of peroxides, chlorosilanes, and acid chlorides.

11. The method of claim 6 wherein said reactant compound is an organo-metallic coupling agent.

12. The method of claim 11 wherein said coupling agent is selected from the group consisting of liquid, multi-functional titanates, zirconates, and aluminates and wherein said contacting comprises spraying a sufficient amount of atomized coupling agent into an fluidized suspension of carbon particles to form at least a partial monomolecular layer of agent on the carbon particle surfaces.

13. The method of claim 12 wherein the amount of coupling agent is in the range of 0.1% to 1.0% by weight of carbon particles, and wherein said coupling agent-treated particles are thereafter dispersed in a liquid vehicle to form a suspension.

14. The method of claim 13 wherein said liquid vehicle is selected from the group consisting of water, alcohol, toluene, and mineral spirits.

15. The method of claim 14 wherein said suspension comprises a paste concentrate containing between 10% and 35% solids.

16. The method of claim 15 wherein said concentrate is later further diluted with said liquid vehicle to form an ink.

17. The method of claim 16 wherein said liquid vehicle is water.

18. A carbon powder composition produced by the process of claim 1.

19. The composition of claim 18 dispersed in a liquid vehicle to form a suspension.

20. The composition of claim 19 wherein said liquid vehicle is water and wherein said liquid suspension is a printing ink.

21. A method for modifying the surfaces of carbon particles that comprises subjecting the carbon particles to resonance disintegration and contacting the carbon with a reactant compound during or immediately after the resonance disintegration.

22. The method of claim 21 wherein said reactant compound binds to carbon particle surfaces through Van der Walls forces.

23. The method of claim 21 wherein said reactant compound chemically reacts with functional groups present on the carbon particle surfaces.

24. The method of claim 23 wherein said reactant wherein said reactant compound is selected from the group consisting of peroxides, chlorosilanes, and acid chlorides.

25. The method of claim 21 wherein said reactant compound is an organo-metallic coupling agent.

26. The method of claim 21 wherein said coupling agent is selected from the group consisting of liquid, multi-functional titanates, zirconates, and aluminates and wherein said contacting comprises spraying a sufficient amount of atomized coupling agent into an fluidized suspension of carbon particles to form at least a partial monomolecular layer of agent on the carbon particle surfaces.

27 The method of claim 26 wherein the amount of coupling agent is in the range of 0.1% to 1.0% by weight of carbon particles, and wherein said coupling agent-treated particles are thereafter dispersed in a liquid vehicle to form a suspension.
